(19) United States
(12) Patent Application Publication
(10) Pub. No.: US 2022/0299717 A1
(43) Pub. Date: Sep. 22, 2022

(54) CONTACTLESS CONNECTOR AND CONTACTLESS CONNECTOR ASSEMBLY

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: TUNG-LOU LIN, New Taipei (TW); CHANG-TENG HSU, New Taipei (TW); HAI-JUN XU, Kunshan (CN); CHENG-HSIU LU, New Taipei (TW); CHAO-CHUNG CHANG, New Taipei (TW)

(21) Appl. No.: 17/696,673

(22) Filed: Mar. 16, 2022

(30) Foreign Application Priority Data
Mar. 18, 2021 (CN) 202110292124.1

(51) Int. Cl. G02B 6/42

(52) U.S. Cl. CPC G02B 6/4225; G02B 6/4292

(57) ABSTRACT

A contactless connector includes: a light emitter for emitting light; a light-transmitting member at least partially covering the light emitter; and an alignment mechanism that enables an alignment error between the light emitter and a light receiver on another contactless connector to be not greater than 5 microns; wherein the light-transmitting member includes a mating surface that is matched with an opposite surface of the another contactless connector and there is an elastic member on the opposite surface of the another contactless connector to adjust alignment of the alignment mechanism.

### BACKGROUND OF THE INVENTION

### 1. Field of the Invention

The present invention relates generally to a contactless connector and a contactless connector assembly including the contactless connector, and more particularly to a contactless connector and a contactless connector assembly capable of transmission of light signal.

### 2. Description of Related Arts

With the popularization of Internet technology and calculator technology in daily life, during data transmission, people often use physical contact between electrical connectors to transmit data between different electronic devices to connect one electronic device to another electronic device, frequent insertion and extraction operations will inevitably lead to structural damage to these electrical connectors, resulting in poor contact and shortening the life of the electrical connectors.

Wireless data transmission (such as Bluetooth and Wi-Fi transmission) through a contactless interface instead of the usual electrical connectors, solves the above disadvantages. However, due to the limitation of transfer rate, wireless data transfer is not suitable for mass data transfer, and transferring relatively large files will take a lot of time. In addition, data security is also a technical problem to be solved by wireless data transmission.

Improved contactless connector and contactless connector assembly are desired.

### SUMMARY OF THE INVENTION

A main object of the present invention is to provide a contactless connector that enables efficient transmission of signals.

To achieve the above-mentioned object, a contactless connector comprises: a light emitter for emitting light; a light-transmitting member at least partially covering the light emitter; and an alignment mechanism that enables an alignment error between the light emitter and a light receiver on another contactless connector to be not greater than 5 microns; wherein the light-transmitting member includes a mating surface that is matched with an opposite surface of the another contactless connector and there is an elastic member on the opposite surface of the another contactless connector to adjust alignment of the alignment mechanism.

Another main object of the present invention is to provide a contactless connector assembly that can transmit signals through light.

To achieve the above-mentioned object, a contactless connector assembly comprises: a first contactless connector including a light emitter for emitting light and a light-transmitting member at least partially covering the light emitter; a second contactless connector cooperating with the first contactless connector to transmit signals and including a light receiver and a second light-transmitting member at least partially covering the light receiver; and an alignment mechanism that enables an alignment error between the light emitter and the light receiver to be not greater than 5 microns.

Compared to prior art, the contactless connector and the contactless connector assembly of the present invention transmit data through optical signals to form a contactless transmission interface, and the alignment mechanism ensures the effective transmission of signals between the two contactless connectors. The contactless connector assembly of the present invention has broad application prospects, and it transmits data through optical signals and achieves precise alignment to ensure effective signal transmission.

### BRIEF DESCRIPTION OF THE DRAWING

FIG. 1 is a perspective view of a contactless connector assembly in accordance with the present invention;

FIG. 2 is an exploded view of the contactless connector assembly in FIG. 1 with the addition of the housing;

FIG. 3 is another exploded view of the contactless connector assembly in FIG. 2;

FIG. 4 is an exploded view of the first contactless connector in FIG. 1;

FIG. 5 is an exploded view of the second contactless connector in FIG. 1;

FIG. 6 is a cross-sectional view along line 6-6 of the first embodiment of the alignment mechanism of the contactless connector assembly in FIG. 1;

FIG. 7 is a cross-sectional view of the contactless connector assembly in FIG. 6 after mating;

FIG. 8 is a perspective view of the second embodiment of alignment mechanism of the contactless connector assembly;

FIG. 9 is a cross-sectional view along line 9-9 of the contactless connector assembly in FIG. 8;

FIG. 10 is a perspective view of the third embodiment of alignment mechanism of the contactless connector assembly;

FIG. 11 is a cross-section view along line 11-11 of the contactless connector assembly in FIG. 10;

FIG. 12 is cross-section view of the contactless connector assembly in FIG. 11 after mating;

FIG. 13 is a perspective view of the fourth embodiment of alignment mechanism of the contactless connector assembly;

FIG. 14 is a cross-section view along line 14-14 of the contactless connector assembly in FIG. 13;

FIG. 15 is a perspective view of the fifth embodiment of alignment mechanism of the contactless connector assembly;

FIG. 16 is another perspective view of the contactless connector assembly in FIG. 15;

FIG. 17 is a cross-section view along line 17-17 of the contactless connector assembly in FIG. 15;

FIG. 18 is a perspective view of the sixth embodiment of alignment mechanism of the contactless connector assembly;

FIG. 19 is a cross-section view along line 19-19 of the contactless connector assembly in FIG. 18; and

FIG. 20 is an application scenario of the contactless connector assembly, in FIG. 1, which is respectively set on the mobile phone and its corresponding base; and

FIG. 21 is a perspective view removing other external structures from the mobile phone and removing other external structures of corresponding base in FIG. 20.

### DETAILED DESCRIPTION OF THE PREFERRED EMBODIMENT

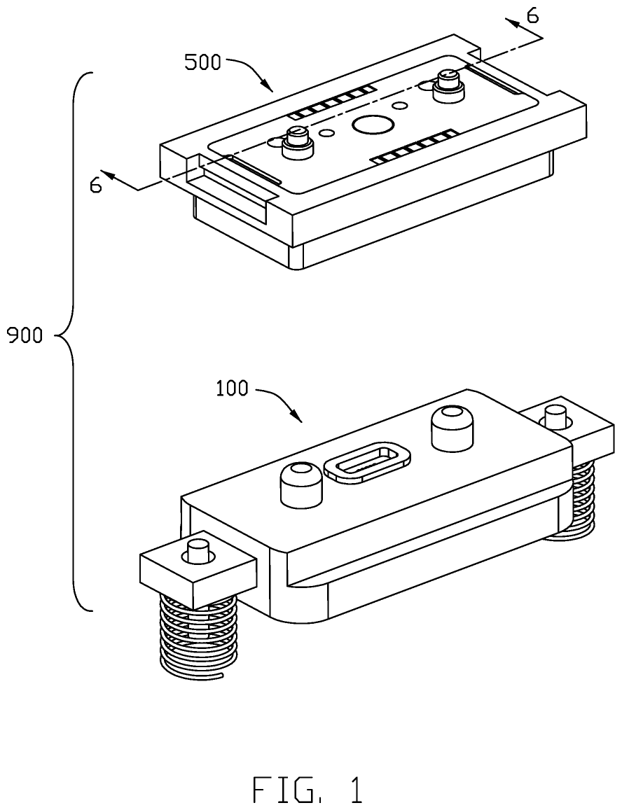

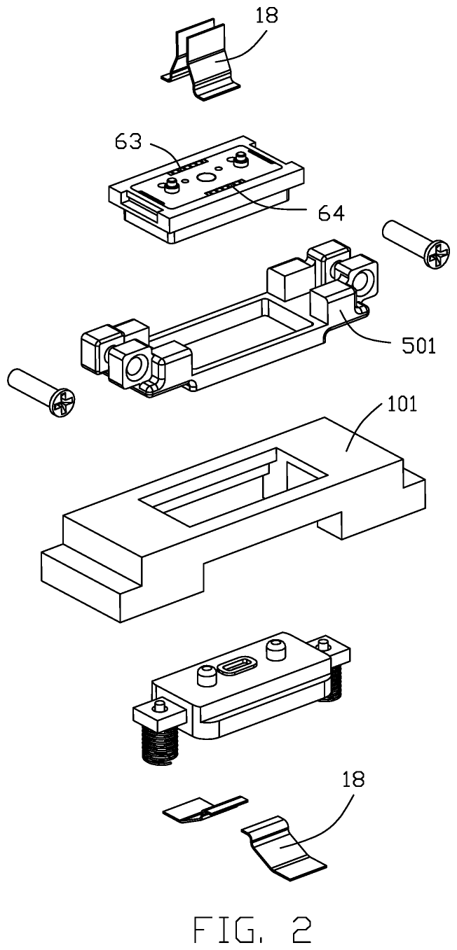

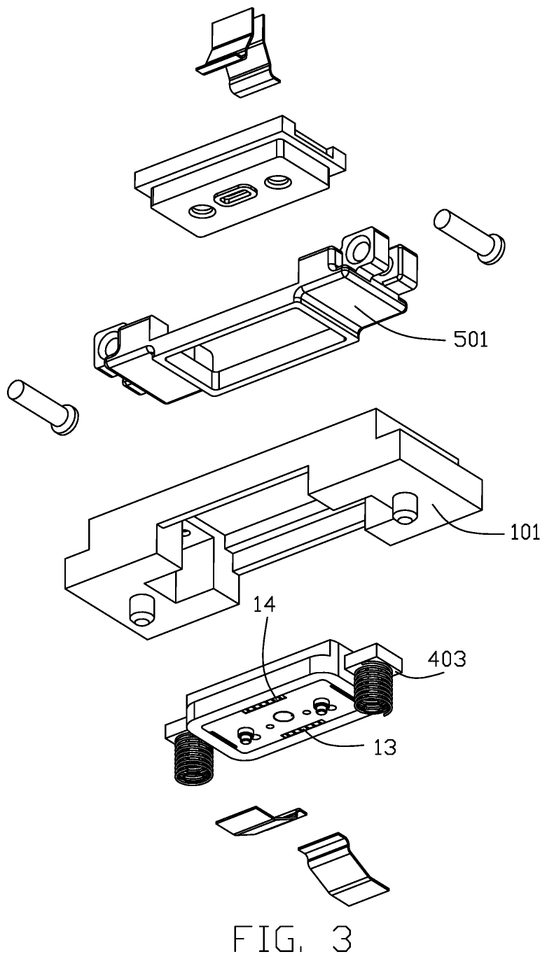

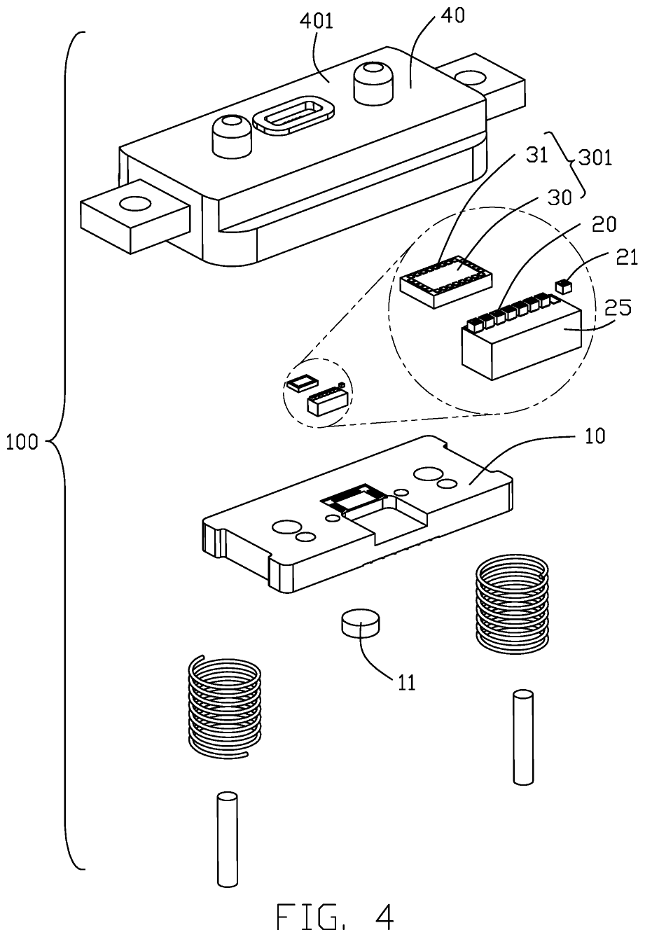

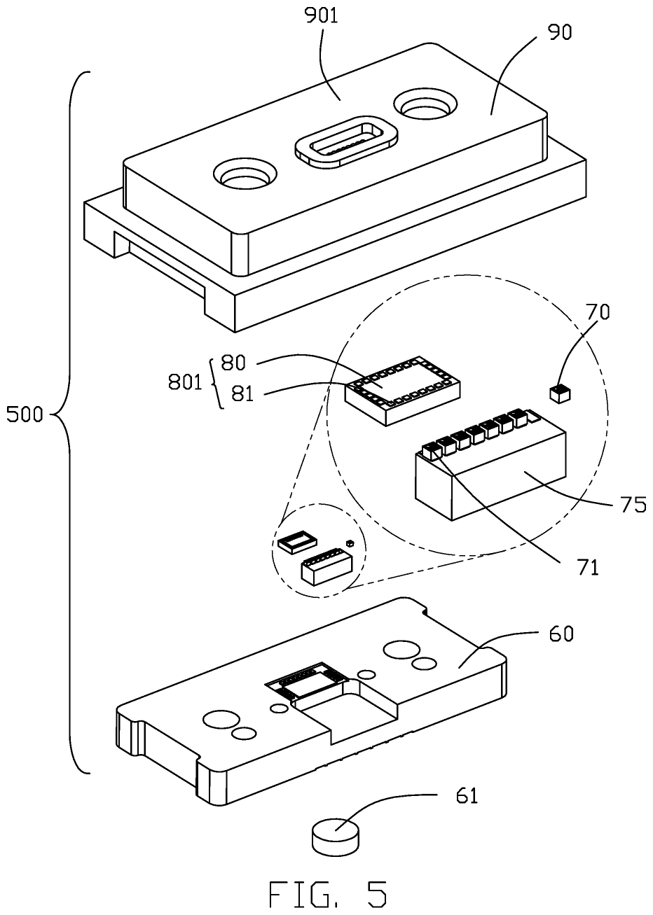

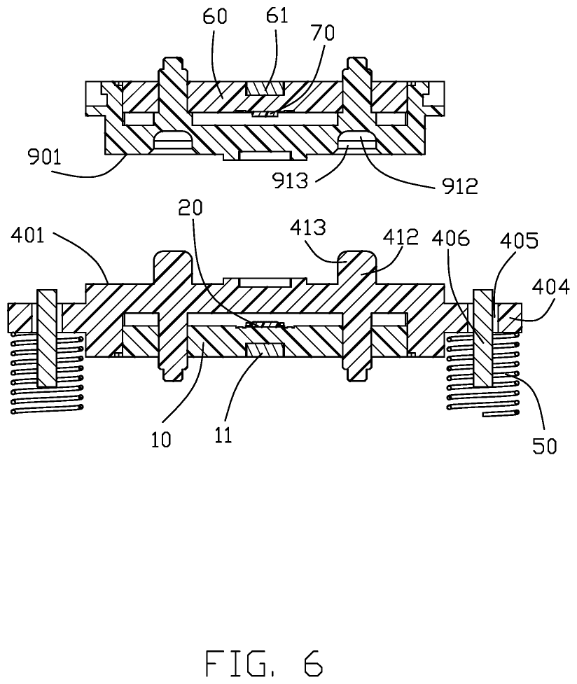

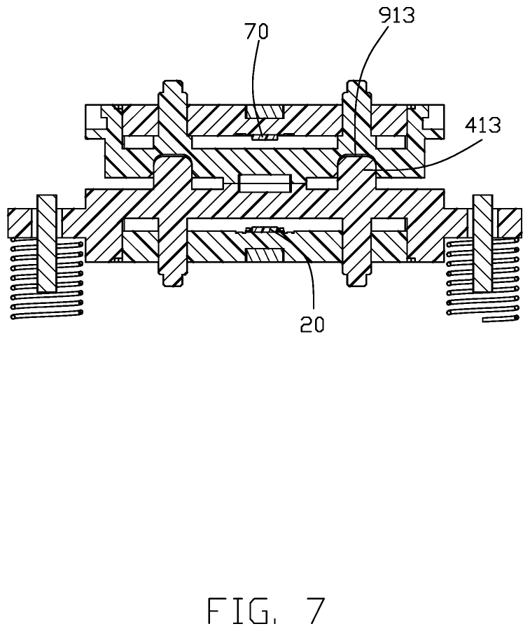

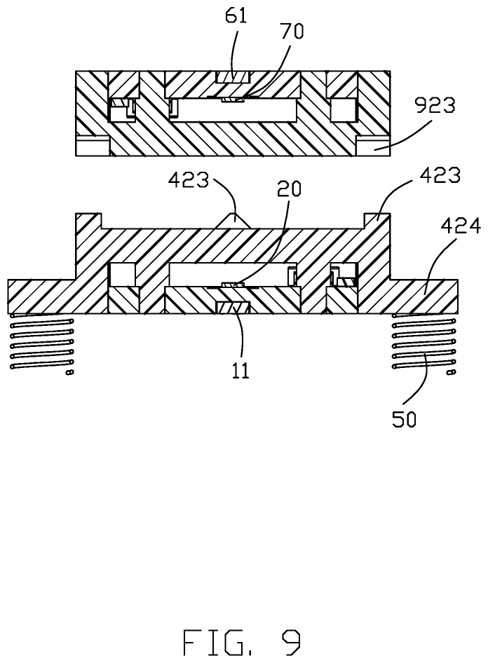

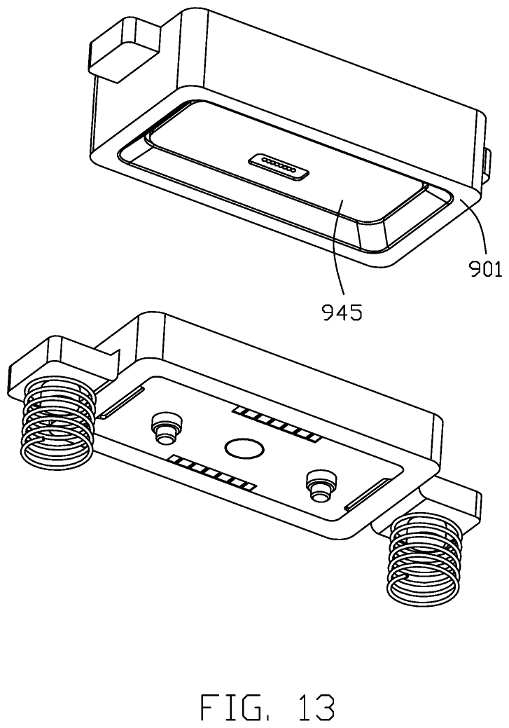

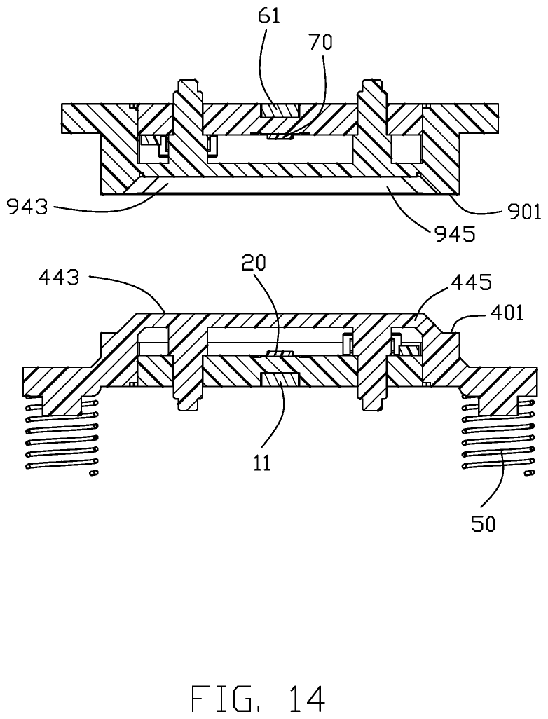

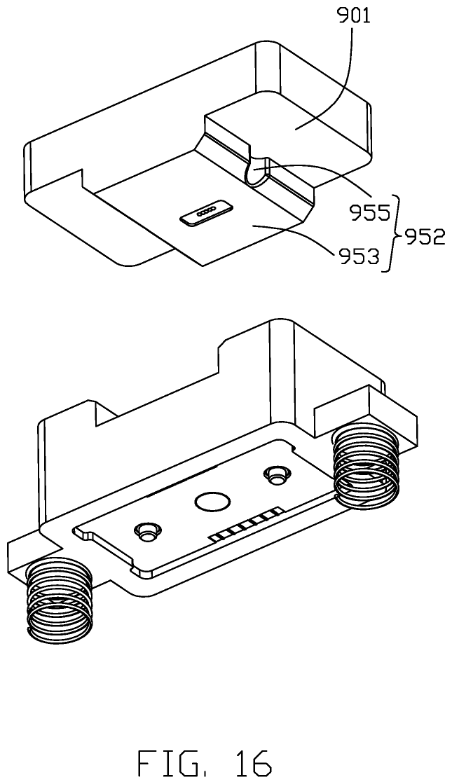

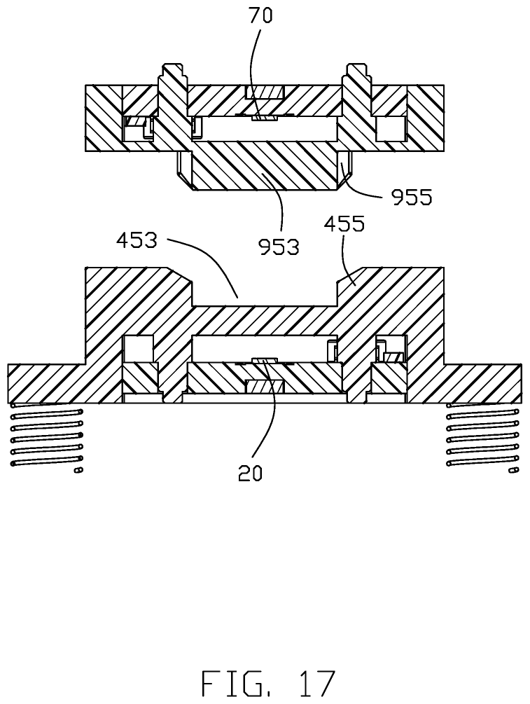

Referring to FIGS. 1-19, a contactless connector assembly 900 in accordance with the present invention is shown. The contactless connector assembly 900 comprises a first contactless connector 100 and a second contactless connector 500 that can cooperate with each other to transmit signals. A contactless optical transmission interface is formed between the first contactless connector 100 and the second contactless connector 500.

Referring to FIGS. 1-6, the first contactless connector 100 comprises a first circuit board 10, a light emitter 20 disposed on the first circuit board 10 and capable of converting electrical signals into optical signals, a light emitter control chip 30 disposed on the first circuit board 10 and capable of controlling the light emitter 20 to work, and a first light-transmitting member 40 at least partially covering the first circuit board 10, the light emitter 20 and the light emitter control chip 30. The second contactless connector 500 comprises a second circuit board 60, a light receiver 70 disposed on the second circuit board 60 that can receive the light signals sent by the light emitter 20 and convert the received light signals into electrical signals, an amplifier chip 80 that amplifies the electrical signals, and a second light-transmitting member 90 at least partially covering the second circuit board 60, the light receiver 70 and the amplifier chip 80. The first light-transmitting member 40 and the second light-transmitting member 90 do not affect the transmission and reception of signals. The first light-transmitting member 40 and the second light-transmitting member 90 can be made of PEI material or glass material, or the outside is made of PEI material or glass material, and the inside is filled with water or air.

The first contactless connector 100 in the present invention has the function of converting electrical signals into optical signals and sending out optical signals. The second contactless connector 500 has the function of receiving the optical signals and converting the optical signals to electrical signals. The first contactless connector 100 and the second contactless connector 500 can both have the functions of sending out and receiving optical signals. Specifically, it is achieved by the following, the first contactless connector 100 further includes a second light receiver 21 that can receive optical signals and convert the received optical signals into electrical signals, and a second amplifier chip 31 that amplifies the electrical signals. The second amplifier chip 31 and the light emitter control chip 30 are integrated into a single chip 301. The second contactless connector 500 further includes a second light emitter 71 that can convert electrical signals into optical signals, and a second light emitter control chip 81 disposed on the second circuit board 60 for controlling the work of the second light emitter 71. The amplifier chip 80 and the second light emitter control chip 81 are integrated into a single chip 801. The amplifier chip 80 and the second amplifier chip 31 are both post-amplifier integrated circuit controller. The light emitter control chip 30 and the second light emitter control chip 81 are both laser diode drive controllers. The wavelength of the light emitted by the light emitter 20 and the second light emitter 71 is 850 nm. The wavelength of light emitted by the light emitter 20 can also be other suitable wavelengths. Both the second light receiver 21 and the light receiver 70 can be gallium arsenide photodiodes or indium phosphide photodiodes. As required, one or more optical paths may be set between the first contactless connector 100 and the second contactless connector 500. Specifically, it can be realized by the following: the light emitter 20 and the second light receiver 21 can be set as one or more, and the corresponding light receivers 70 and the second light emitter 71 can be set as one or more. The first circuit board 10 is provided with conductive pads 13 for inputting electrical signals and conductive pads 14 for outputting electrical signals. The second circuit board 60 is provided with conductive pads 63 for inputting electrical signals and conductive pad 64 for outputting electrical signals. Each conductive pad can be connected to the spring terminal of the board end base (not shown) or connected to the flexible board 18.

The first contactless connector 100 further includes a first mounting seat 25 mounted on the first circuit board 10, The light emitter 20 and the second light receiver 21 can be mounted on the first mounting seat 25. The height of the first mounting seat 25 is designed according to actual needs. The light emitter 20 and the second light receiver 21 can also be directly mounted on the first circuit board 10. Similarly, the second contactless connector 500 may also include a second mounting seat 75 mounted on the second circuit board.

The contactless connector of the present invention has a smaller size. In the present invention, each of the first contactless connector 100 and the second contactless connector is substantially rectangular, with a length of 18.5 mm, a width of 10 mm, and a height of 5 mm.

For ease of understanding, in the following description, the first contactless connector 100 is only provided with the light emitter 20, and the second contactless connector 500 is only provided with the light receiver 70. The contactless connector assembly 900 further includes an alignment mechanism so that the alignment error of the light emitter 20 and the light receiver 70 is no greater than 5 microns. The first light-transmitting member 40 includes a first matching surface 401, and the second light-transmitting member 90 includes a second matching surface 901 that cooperates with the first matching surface 401. There is an elastic member 50 provided on the surface 403 opposite to the first matching surface 401 of the first light-transmitting member 40 for adjusting the alignment of the alignment mechanism. Specifically, in this embodiment, the elastic member 50 is a spring. The first contactless connector 100 further includes a first magnetic element 11 disposed on the first circuit board 10. The first magnetic element 11 and the light emitter are disposed on opposite sides of the first circuit board 10. The second contactless connector 500 further includes a second magnetic element 61 disposed on the second circuit board 60. The second magnetic element 61 and the light receiver 70 are disposed on opposite sides of the second circuit board 60. The first magnetic element 11 and the second magnetic element 31 are attracted to each other to align the alignment mechanisms with each other and provide the mating force between the first contactless connector 100 and the second contactless connector 500. Both the magnetic element 11 and the magnetic element 61 can be magnets. The first contactless connector 100 further comprises a first housing 101 for securing it. The second contactless connector 500 further includes a second housing 501 for securing it.

Referring to FIGS. 1-7, a first embodiment of alignment mechanism of the contactless connector assembly in accordance with the present invention is shown. The alignment mechanism includes a first matching portion 412 disposed on the first matching surface 401 and a second matching portion 912 disposed on the second matching surface 901. One of the first matching portion 412 and the second matching portion 912 is a recessed portion, and the other is a protruding portion matched with the corresponding recessed portion. Specifically, in this embodiment, the first matching portion 412 is a protruding portion 413, and the second matching portion 912 is a recessed portion 913. A pair of the protruding portion 413 symmetrically arranged on the two sides of the light emitter 20, and a pair of the recessed portions 913 symmetrically arranged on corresponding two sides of the light receiver 70. The shape of the protruding portion 413 and the recessed portion 913 are cylindrical that can be matched to each other. The two sides of the first light-transmitting member 40 are provided with flange portions 404 protruding outward respectively, and the flange portions 404 are provided with through holes 405. A pair of guide posts 406 installed in the corresponding through holes 405. The springs 50 is located on the lower side of the flange portion 404, and the guide posts 406 is passed through the corresponding spring. The guide post 406 and the first light-transmitting member 40 may also be integrally formed by insert molding.

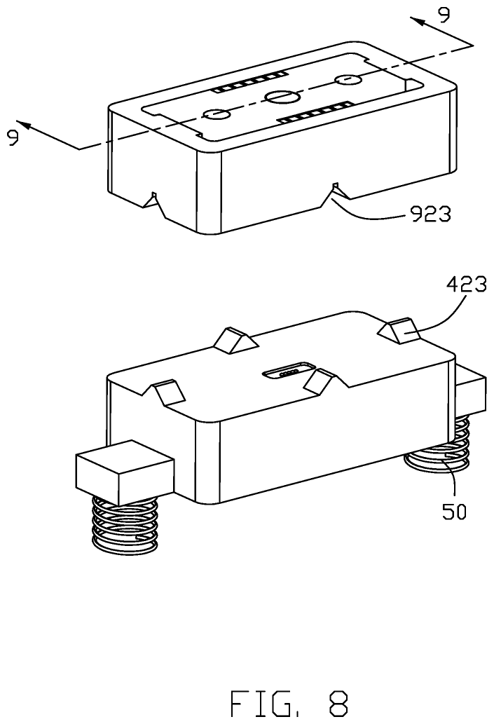

Referring to FIGS. 8-10, a second embodiment of alignment mechanism of the contactless connector assembly in accordance with the present invention is shown. In this embodiment, the protruding portions 423 are symmetrically arranged around the light emitter 20, the recessed portions 923 are symmetrically arranged around the light receiver 70. The shape of the protruding portion 423 and the recessed portions 923 is triangle that can be match with each other. The spring 50 is located on the lower side of the flange portion 424.

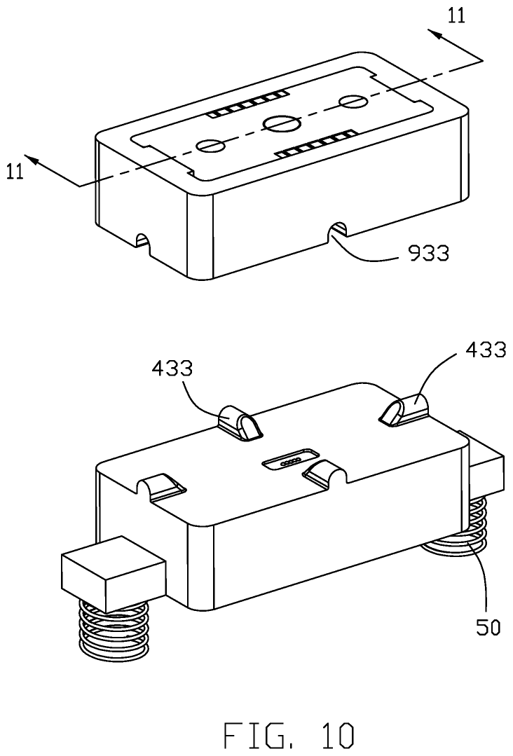

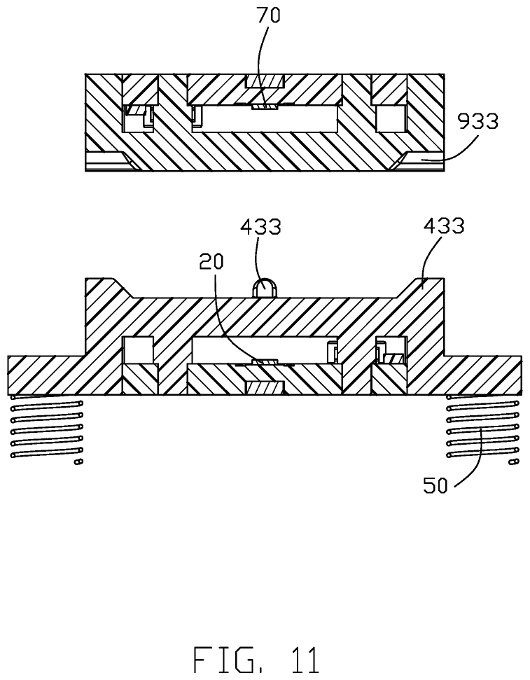

Referring to FIGS. 10-11, a third embodiment of alignment mechanism of the contactless connector assembly in accordance with the present invention is shown. Compared with the second embodiment, in this embodiment, the shape of the protruding portion 433 and the recessed portion 933 is a U-shaped that matches each other.

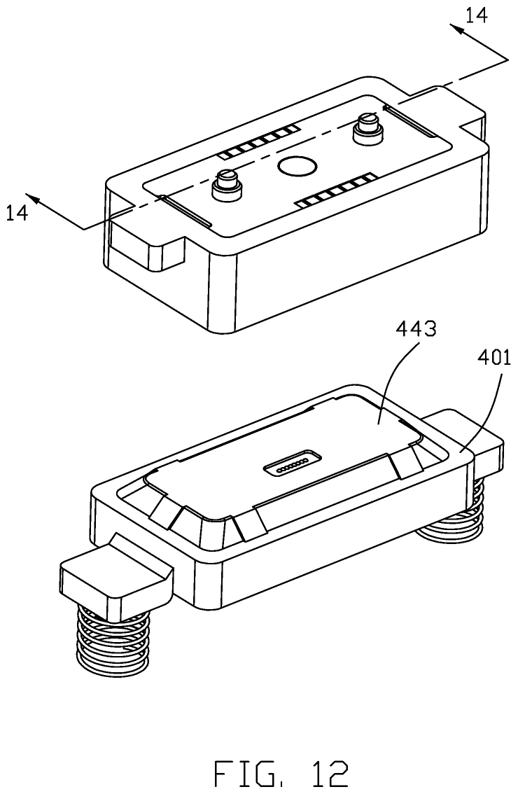

Referring to FIGS. 12-14, a forth embodiment of alignment mechanism of the contactless connector assembly in accordance with the present invention is shown. Compared with the previous embodiment, in this embodiment, the protruding portion 443 is an integral protruding block 445 protruding from the first matching surface 401, the recessed portion 943 is an integral groove 945 that is recessed to the second matching surface 901. The perimeter edge of the protruding block 445 is inclined, and the perimeter edge of the groove 945 is inclined to match the perimeter edge of the protruding block 445.

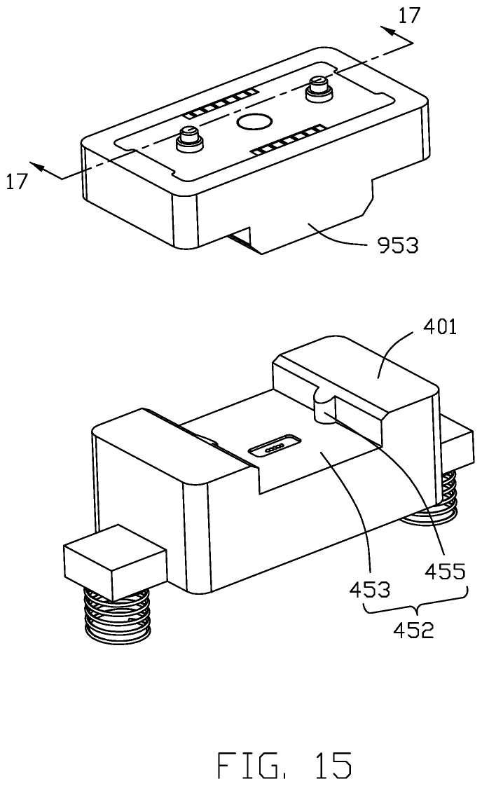

Referring to FIGS. 15-17, a fifth embodiment of alignment mechanism of the contactless connector assembly in accordance with the present invention is shown. Compared with the previous embodiment, in this embodiment, the first matching portion 452 includes a groove 453 recessed from the first matching surface 401, and a positioning protrusion 455 protruding from the two side walls of the groove 453 toward the groove 453. The groove 453 penetrates along the first direction. The second matching portion 952 includes a protrusion 953 protruding outward from the second matching surface 901 that matches the groove 453, and positioning grooves 955 that matches the positioning protrusions 455 is provided on the protrusion 953.

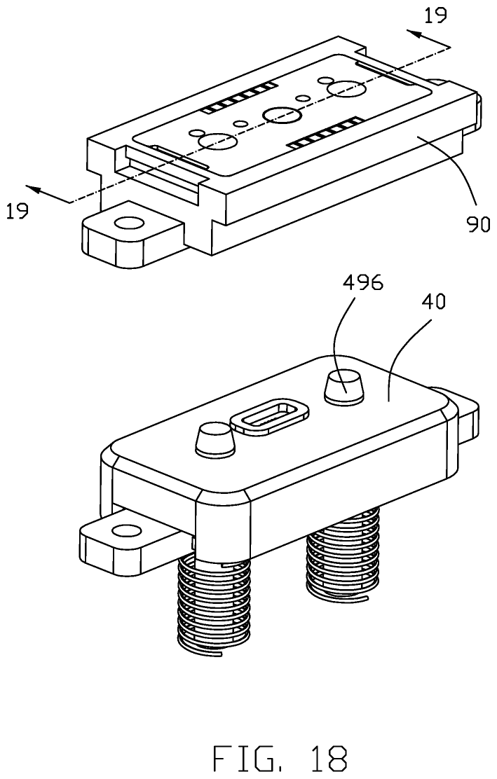

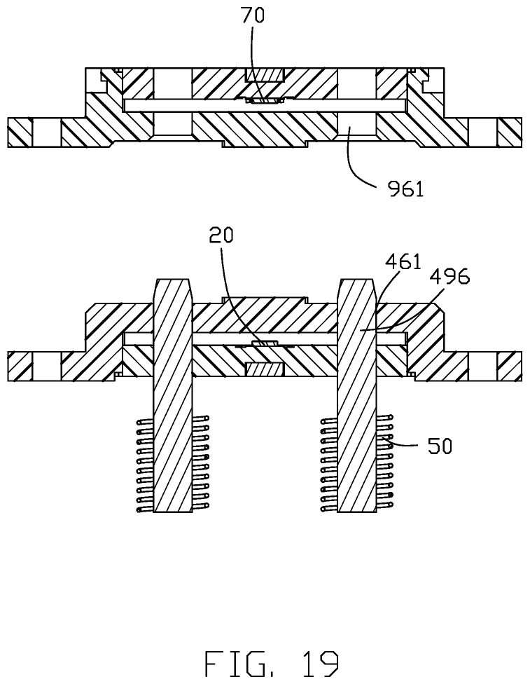

Referring to FIGS. 18-19, a sixth embodiment of alignment mechanism of the contactless connector assembly in accordance with the present invention is shown. Compared with the previous embodiment, in this embodiment, the alignment mechanism includes two first holes 461 located on the left and right sides of the light emitter 20 and passing through the first light-transmitting member 40, two second holes 961 located on the left and right sides of the light receiver 70 of the second light-transmitting member 90, and a positioning post 496 co-located in the first hole 461 and the second hole 961. The spring 50 is mounted on the positioning post 496.

The contactless connector and the contactless connector assembly of the present invention form a contactless transmission interface, transmit data through optical signals, and the alignment mechanism ensures the effective transmission of signals between the two contactless connectors. The contactless connector assembly 900 of the present invention has broad application prospects. It can be applied to interfaces that need to transmit high-speed data and video, such as data center switches, it can be applied to equipment that is extremely sensitive to EMI, such as medical and military. In addition, the optical signal can be transmitted in air or liquid, and it can transmit a variety of signals because of the chip and photoelectric conversion functions, such as LVDS (Low Voltage Differential Signaling), TMDS (Time Minimized Differential Signaling), CML (Current Mode Logic) and other signals that can be transmitted.

The contactless connector of the present invention has a very small size and can be applied to 3C consumer products, such as mobile phones, notebooks or tablet computers, and it can also available for short-distance and high-speed board connections, such as data center switches or servers. It can also be used as anti-electromagnetic interference equipment such as operating table endoscope. It's also available to connect the two connectors via optical fiber to transmit the signal inside the large panel or TV GPU (graphics card) to the controller.

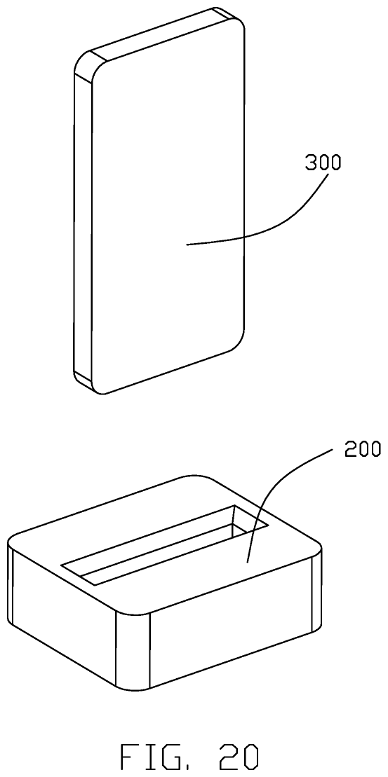

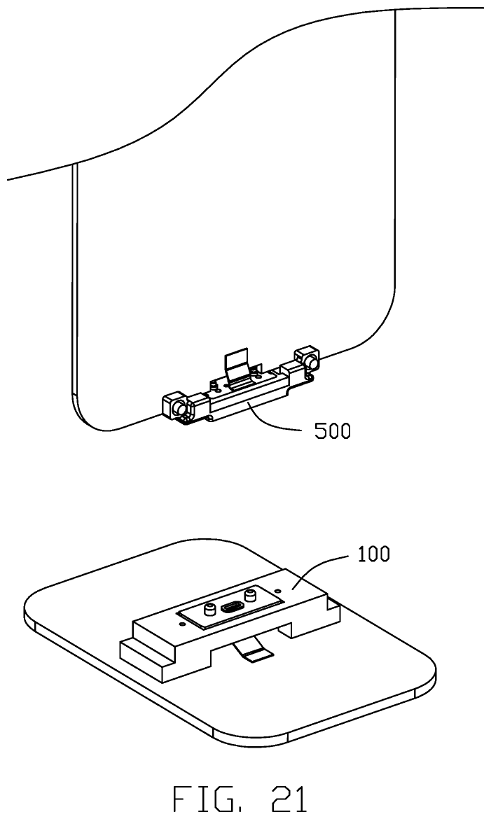

Referring to FIGS. 20-21, an application scenario of the contactless connector assembly 900 of the present invention, in this application scenario, the first contactless connector 100 is located in the base 200, and the second contactless connector 500 is located in the mobile phone 300. The first housing 101 is an integral part of the base 200, and the second housing 501 is an integral part of the mobile phone 300.

The contactless connector assembly of the present invention can be used for wireless charging, signal transmission between wireless phones, double panels and detachable laptops, foldable and expandable laptop applications, video wall applications, internal transmission for a large TV or laptop. In addition, the contactless connector and connector assembly of the present invention realize signal transmission through optical signals, with low loss and stable signal transmission, and the contactless connector can be used in many fields. The optical communication module includes an optical signal emitter and an optical signal receiver, the optical signal emitter and the optical signal receiver are aligned by the engagement of the positioning pins and the positioning grooves, and the attraction of the magnets. The optical signal receiver is mechanically coupled to the optical transceiver to ensure light transmission through the transceiver's lens and the receiver's lens.

What is claimed is:

1. A contactless connector comprising:
a light emitter for emitting light;
a light-transmitting member at least partially covering the light emitter; and
an alignment mechanism that enables an alignment error between the light emitter and a light receiver on another contactless connector to be not greater than 5 microns; wherein
the light-transmitting member includes a mating surface that is matched with an opposite surface of the another contactless connector and there is an elastic member on the opposite surface of the another contactless connector to adjust alignment of the alignment mechanism.

2. A contactless connector assembly comprising:
a first contactless connector comprising:
a light emitter for emitting light; and
a light-transmitting member at least partially covering the light emitter;
a second contactless connector cooperating with the first contactless connector to transmit signals and comprising:
a light receiver; and
a second light-transmitting member at least partially covering the light receiver; and
an alignment mechanism that enables an alignment error between the light emitter and the light receiver to be not greater than 5 microns.

3. The contactless connector assembly as claimed in claim 2, wherein the first light-transmitting member includes a first matching surface, the second light-transmitting member includes a second matching surface that cooperates with the first matching surface, and the elastic member adjusting the alignment of the alignment mechanism on the side opposite to the first matching surface of the first light-transmitting member.

4. The contactless connector assembly as claimed in claim 3, wherein the first contactless connector includes a first magnetic element, and the second contactless connector includes a second magnetic element, the first magnetic element and the second magnetic element are magnetically attracted to each other to align the alignment mechanisms and provide the mating force of the first contactless connector and the second contactless connector.

5. The contactless connector assembly as claimed in claim 4, wherein the alignment mechanism includes a first matching portion provided on the first matching surface and a second matching portion provided on the second matching surface and matched with the first matching portion.

6. The contactless connector assembly as claimed in claim 5, wherein one of the first matching portion and the second matching portion is a recessed portion, and the other is a protruding portion that matched with the recessed portion.

7. The contactless connector assembly as claimed in claim 5, wherein the protruding portion and the recessed portion are symmetrically arranged on the two sides of the corresponding light emitter or the light receiver, and the protruding portion and the recessed portion are of cylindrical shapes that match each other.

8. The contactless connector assembly as claimed in claim 5, wherein the protruding portion and the recessed portion are symmetrically arranged around the light transmitter or the light receiver, and the protruding portion and the recessed portion are matched triangles.

9. The contactless connector assembly as claimed in claim 5, wherein the protruding portion and the recessed portion are symmetrically arranged around the light transmitter or the light receiver, and the protruding portion and the recessed portion are matched U-shapes.

10. The contactless connector assembly as claimed in claim 5, wherein the protruding portion is an integral protrusion with an inclined periphery, and the recessed portion is an integral groove with an inclined periphery matched with the integral protrusion.

11. The contactless connector assembly as claimed in claim 5, wherein the first matching portion includes a groove that is recessed inward from the first matching surface, and a protrusion that protrudes outward from the second matching surface and matches the groove, the groove is provided with positioning protrusions that protrude from the two side walls of the groove, and the protrusions are provided with positioning grooves that match the positioning protrusions.

12. The contactless connector assembly as claimed in claim 4, wherein the alignment mechanism includes a pair of first holes on first light-transmitting member on the two sides of the light emitter, a pair of second holes located on the two sides of the light receiver of the second light-transmitting member, and a pair of positioning posts passing through the corresponding first holes and the second holes, the first hole passing through the first light-transmitting member.
